(19) United States
(12) Patent Application Publication
(10) Pub. No.: US 2007/0076990 A1
(43) Pub. Date: Apr. 5, 2007

(54) Motor and bearing structure thereof

(75) Inventors: Meng-Hsiu Tsai, Taoyuan Hsien (TW); Shang-Yen Tsai, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/528,447

(22) Filed: Sep. 28, 2006

(30) Foreign Application Priority Data
Sep. 30, 2005 (TW) 094134270

(51) Int. Cl. F16C 32/06; F16C 33/02; F16C 43/00

(52) U.S. Cl. 384/100; 384/295; 384/537

(57) ABSTRACT

A bearing structure coupled to a shaft includes a bearing and a cover element. The cover element is held to the bearing and covers at least one portion of one end of the bearing. The cover element has a turning portion, which has a groove. A motor comprises a rotor structure, a stator structure and a bearing structure. The rotor structure has a hub and a shaft connecting to the hub. The stator structure has a hole, and the shaft is disposed in the hole. The bearing structure has a bearing and a cover element. The bearing is disposed in the shaft hole and coupled to the shaft. The cover element is held to the bearing and covers at least one portion of one end of the bearing. The cover element comprises a turning portion.

### BACKGROUND OF THE INVENTION

1. Field of Invention

The invention relates to a motor and a bearing structure thereof and, in particular, to a motor that can overcome the element and assembling errors and a bearing structure thereof.

2. Related Art

Motors have been widely used in electronic devices. As the electronic devices become smaller, the sizes of motors are also reduced while their speeds are increased. Therefore, how to reduce vibrations and noises during high-speed operations is an important issue of the motor.

As shown in FIG. 1, a conventional motor 1 includes a rotor structure 10, a stator structure 20, and a bearing structure 30. The stator structure 20 drives the rotator structure 10. One shaft 101 of the rotor structure 10 is installed in a shaft hole 201 formed by a sleeve 21 of the stator structure 20. The bearing structure 30 has a bearing 301 and a cover element 302. The bearing 301 is mounted in the sleeve 21 and coupled to the shaft 101. The cover element 302 is disposed in the sleeve 21 and only touches the top-surface of the bearing 301. When the rotor structure 10 rotates, the bearing 301 rotates with the shaft 101. The cover element 302 provides an axial stop for preventing the bearing 301 from displacing in the axial direction as it rotates with the shaft 101. Besides, an adhesive can be used to connect the bottom surface of the cover element 302 and the top-surface of the bearing 301 so as to provide the bearing with an anti-torque.

As described above, the cover element 302 only provides the axial stop. Since the sleeve 21 and the cover element 302 interfere with each other, the inner diameters of the bearing 301 and the cover element 302 may shrink so that they may touch the shaft 101. Moreover, even though the use of the adhesive provides the cover element 302 with an anti-torque, its effect varies with the material or the operation environment.

It is therefore an important subject of the invention to provide a motor and the bearing structure thereof to solve the above-mentioned problems. The invention can overcome the element and assembling errors, so that the shaft keeps an appropriate distance from the bearing or the cover element. This can reduce possible vibrations and noises during high-speed operations of the motor.

### SUMMARY OF THE INVENTION

In view of the foregoing, the invention is to provide a motor and a bearing structure thereof that can overcome the element and assembling errors.

To achieve the above, a bearing structure according to the invention, which is coupled to a shaft, includes a bearing and a cover element. The bearing is coupled to the shaft. The cover element is held to the bearing and covers at least one portion of one end of the bearing. The cover element includes a turning portion that has a groove.

In this aspect, the cover element has a first part and a second part. The turning portion is located at the joint between the first part and the second part. The first part has at least a buffer structure for contacting to a side-surface of the bearing.

To achieve the above, a motor of the invention includes a rotor structure, a stator structure, and a bearing structure. The rotor structure includes a hub and a shaft connected to the hub. The stator structure has a shaft hole, and the shaft is disposed in the shaft hole. The bearing structure has a bearing and a cover element. The bearing is disposed in the shaft hole and coupled to the shaft. The cover element urges against the bearing and covers at least one portion of one end of the bearing. The cover element includes a turning portion that has a groove.

In the aspect, the cover element has a first part and a second part. The turning portion is located at the joint between the first part and the second part. The first part has at least a buffer structure for contacting to a side-surface of the bearing.

The rotor structure further includes a first magnetic device and a second magnetic device, which are respectively disposed on the inner-surface of the hub and the cover element in the opposite positions.

As mentioned above, the motor and the bearing structure thereof of the invention use the cover element in the bearing structure to cover one end of the bearing so as to form a turning portion. The turning portion has a groove as a buffer region to alleviate the radial shrinking of the cover element by shrinking of the shaft hole. This prevents the cover element from shrinking its inner diameter to touch the shaft. In other words, this feature of the invention can reduce the gap error between the cover element and the shaft. Moreover, one part of the cover element has at least one buffer structure for contacting to the side-surface of the bearing. The buffer structure provides the bearing with an anti-torque effect and a buffering effect to overcome the device and assembling errors. In comparison with the prior art, the invention also overcomes worries of a varying anti-torque of the bearing as a result of the adhesive under material and environmental changes. In addition, the buffer structure touches the bearing by a small area. The possibility of a shrinking inner diameter in the bearing structure is effectively reduced. Therefore, the cover element of the invention can indeed overcome the device and assembling errors. Moreover, the first magnetic device and the second magnetic device secure the positioning of the bearing structure, which can reduce the vibrations and noises during high-speed operations of the motor.

### BRIEF DESCRIPTION OF THE DRAWINGS

The invention will become more filly understood from the detailed description given herein below illustration only, and thus is not limitative of the present invention, and wherein:

FIG. 1 is a schematic diagram showing the conventional motor;

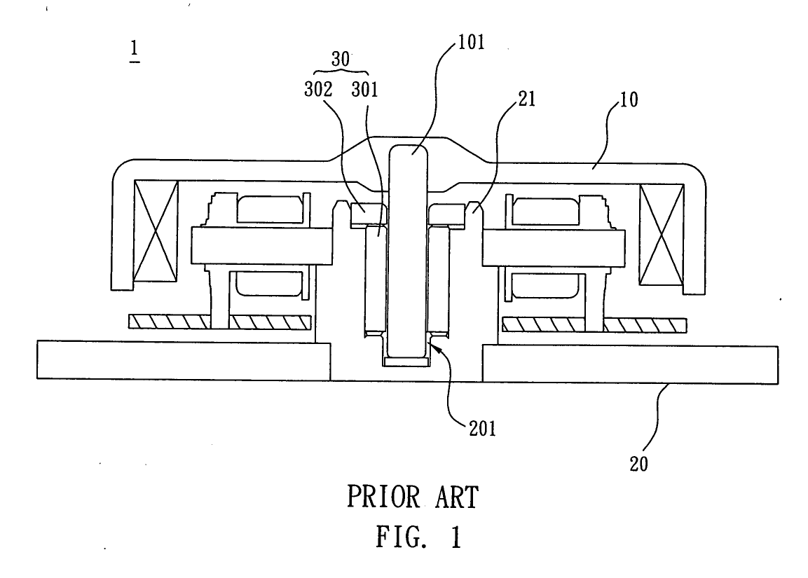

FIG. 2 is a schematic diagram showing a motor according to a preferred embodiment of the invention;

FIG. 3 is another schematic diagram of the motor according to the preferred embodiment of the invention; and

FIG. 4 is an enlarged view showing a part of the motor according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

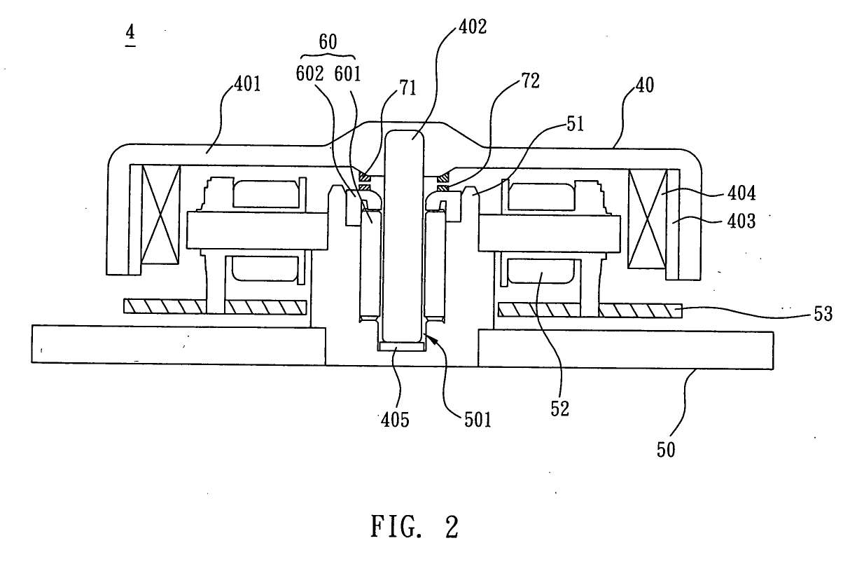

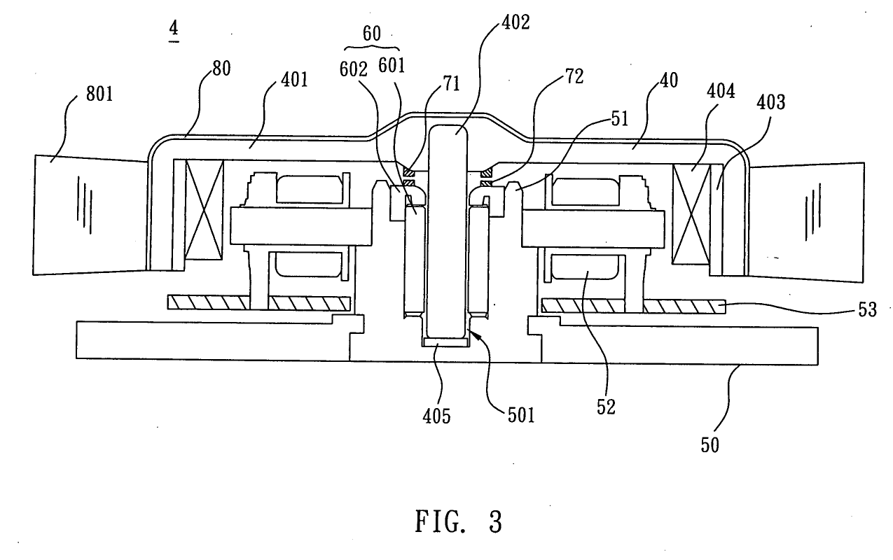

With reference to FIGS. 2 and 3, a motor 4 according to a preferred embodiment of the invention includes a rotor structure 40, a stator structure 50, and a bearing structure 60.

The rotor structure 40 includes a hub 401 and a shaft 402. The shaft 402 is connected to the hub 401. As shown in FIG. 2, the shaft 402 is embedded in the hub 401. Besides, the shaft 402 can be integrally formed with the hub 401 as a single piece.

As described above, the inner surface of the hub 401 is provided in sequence with a magnetic conductive shell 403 and a magnet 404. The magnetic conductive shell 402 is a metal chip. The magnet 404 can be a permanent magnet. In this embodiment, the magnetic conductive shell 403 and the magnet 404 have an annular structure disposed on the inner side of the hub 401.

The rotor structure 40 may further include a shell 80 connected to the outer surface of the hub 401. The shell 80 has several blades 801. The blades 801 rotate with the rotor structure 40 driven by the stator structure 50.

The stator structure 50 has a sleeve 51, a stator pole 52, and a circuit board 53. The sleeve 51 has a shaft hole 501, and the shaft 402 is disposed in the shaft hole 501 of the sleeve 51. An abrasion resistant pad 405 is coupled to one end of the shaft 402. The stator pole 52 is formed by a wound coil and disposed opposite to the magnet 403. Through the magnetic interaction between the stator pole 52 and the magnet 403, the rotor structure 40 and the stator structure 50 produce a relative motion. The circuit board 53 is mounted on the outer side of the sleeve 51 and has a sensor to detect and control the magnetic field of the stator structure 50.

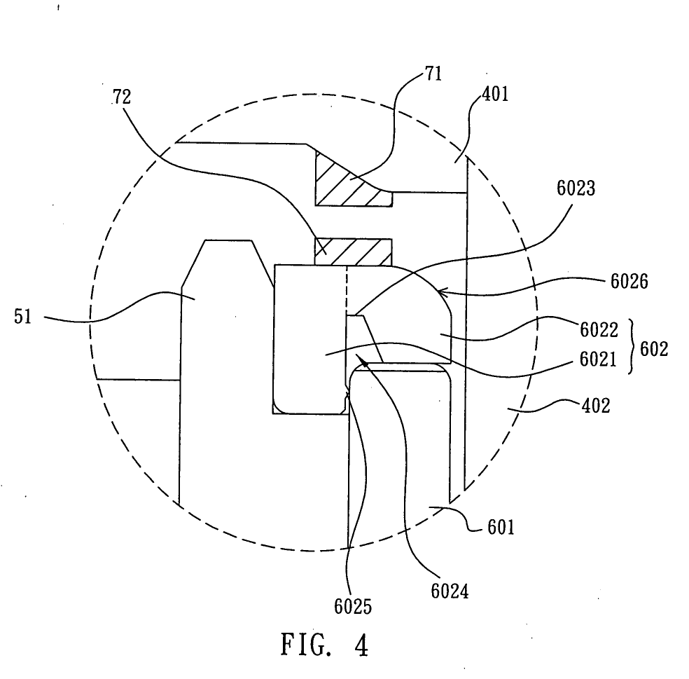

The bearing structure 60 has a bearing 601 and a cover element 602. The bearing 601 is disposed in the shaft hole 501 and coupled to the shaft 402. The bearing 601 can be a ball bearing, a self-lubricating bearing, a fluid dynamic bearing, or a sleeve bearing. The cover element 602 urges against the top-surface and/or the side-surface of the bearing 601 and covers at least a portion of one end of the bearing 601. In this embodiment, the cover element 602 is a U-shaped cover element, an L-shaped cover element or a cap-shaped cover element. FIG. 4 is an enlarged view showing the cross section of the cover element 602. The cover element 602 has a first part 6021 and a second part 6022. A turning portion 6023 is formed at the joint of the first part 6021 and the second part 6022. In more detailed, the first part 6021 covers the side-surface of one end of the bearing 601, whereas the second part 6022 touches against the top-surface of that end of the bearing 601. The turning portion. 6023 has a groove 6024 as a buffer region to alleviate a radial action for preventing the cover element 602 from touching the shaft 402 due to a shrinking of the inner diameter. In this embodiment, the radial action may result from the interference between the sleeve 51 and the cover element 602.

Furthermore, as shown in FIG. 4, the first part 6021 of the cover element 602 has a buffer structure 6025. The buffer structure 6025 is contacted to the side-surface and/or the top-surface of the bearing 601 to provide an anti-torque force to the bearing. The buffer structure 6025 is a structure with a conic protrusion, a round protrusion, or a pillar. Therefore, the buffer structure 6025 touches to the bearing 601 by a contact point or a small area. This reduces the possibility of a shrinking of the inner diameter of the bearing 601 by a pressure opposite to the radial action.

The surface of the cover element 602 facing the shaft 402 has at least one guiding angle 6026. In this embodiment, the guiding angle 6026 is formed on the upper portion of the surface of the cover element 602 that faces the shaft 402. The guiding angle 6026 can be a fillet angle, an arc angle, a tilted angle, or a polygonal angle. As described above, since the guiding angle 6026 has a smaller contact area when a pressure is imposed against the radial action in comparison with a cover element without a guiding angle, the friction between the cover element 602 and the shaft 402 is greatly reduced. Also, as the upper pressure on the surface of the cover element 602 that faces the shaft 402 is larger than the lower pressure due to the guiding angle 6026, it has the function of preventing the lubricant oil filled between the bearing 601 and the shaft 402 from leaking.

The motor 4 according to the preferred embodiment of the invention further includes f first magnetic device 71 and a second magnetic device 72. The first magnetic device 71 is disposed on the inner surface of the hub 401, and the second magnetic device 72 is disposed on the cover element 602 and opposite to the first magnetic device 71. The first magnetic device 71 and the second magnetic device 72 are magnets, electromagnets, or magnetic conductive devices such as iron or silicon steel plates. For example, the first magnetic device 71 can be a magnet or electromagnet, while the second magnetic device 72 can be a magnetic conductive device such as an iron or silicon steel plate. Of course, the first magnetic device 71 may be a magnetic conductive device, while the second magnetic device 72 is a magnet or electromagnet. Besides, the first magnetic device 71 and the second magnetic device 72 can both be magnets or electromagnets. Using the above-mentioned combination, the cover element 602 and the hub 401 can be fixed by the magnetic field to a position. It is thus prevented from touching the shaft 402 due to a shrinking inner diameter.

In summary, the motor and the bearing structure thereof of the invention use the cover element in the bearing structure to cover one end of the bearing so as to form a turning portion. The turning portion has a groove as a buffer region to alleviate the radial shrinking of the cover element by shrinking of the shaft hole. This prevents the cover element from shrinking its inner diameter to touch the shaft. In other words, this feature of the invention can reduce the gap error between the cover element and the shaft. Moreover, one part of the cover element has at least one buffer structure for contacting to the side-surface and/or the top-surface of the bearing. The buffer structure provides the bearing with an anti-torque effect and a buffering effect to overcome the device and assembling errors. In comparison with the prior art, the invention also overcomes worries of a varying anti-torque of the bearing as a result of the adhesive under material and environmental changes. In addition, the buffer structure touches the bearing by a small area. The possibility of a shrinking inner diameter in the bearing structure is effectively reduced. Therefore, the cover element of the invention can indeed overcome the device and assembling errors. Moreover, the first magnetic device and the second magnetic device secure the positioning of the bearing structure, which can reduce the vibrations and noises during high-speed operations of the motor.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A bearing structure coupled to a shaft, comprising:
a bearing coupled to the shaft; and
a cover element held to the bearing and covering at least one portion of one end of the bearing, wherein the cover element comprises a turning portion having a groove.

2. The bearing structure of claim 1, wherein the turning portion has a groove.

3. The bearing structure of claim 1, wherein the cover element further comprises at least one buffer structure contacted to a side-surface and/or a top-surface of the bearing.

4. The bearing structure of claim 3, wherein the buffer structure has a conic protrusion, a round protrusion, or a pillar.

5. The bearing structure of claim 1, wherein the cover element has at least one guiding angle facing the shaft and the guiding angle is a fillet angle, an arc angle, a tilted angle, or a polygonal angle.

6. The bearing structure of claim 1, wherein the bearing is a ball bearing, a self-lubricating bearing, a fluid dynamic bearing, or a sleeve bearing.

7. The bearing structure of claim 1, wherein the cover element is a U-shaped cover element, an L-shaped cover element or a cap-shaped cover element.

8. The bearing structure of claim 1, wherein the cover element urges against a side-surface and a top-surface of the bearing.

9. A motor, comprising:
a rotor structure having a hub and a shaft coupled to the hub;
a stator structure having a hole, wherein the shaft is disposed in the hole; and
a bearing structure having a bearing and a cover element, wherein the bearing is disposed in the hole and coupled to the shaft, the cover element covers one end of the bearing, and the cover element comprises a turning portion.

10. The motor of claim 9, wherein the turning portion has a groove.

11. The motor of claim 9, wherein the cover element further comprises at least one buffer structure contacted to a side-surface and/or a top-surface of the bearing.

12. The motor of claim 11, wherein the buffer structure has a conic protrusion, a round protrusion, or a pillar.

13. The motor of claim 9, wherein the cover element has at least one guiding angle and the guiding angle is a fillet angle, an arc angle, a tilted angle, or a polygonal angle.

14. The motor of claim 9, wherein the bearing is a ball bearing, a self-lubricating bearing, a fluid dynamic bearing, or a sleeve bearing.

15. The motor of claim 9, wherein the cover element is a U-shaped cover element, an L-shaped cover element or a cap-shaped cover element.

16. The motor of claim 9, wherein the cover element urges against a side-surface and a top-surface of the bearing.

17. The motor of claim 9, wherein the rotor structure further comprises a first magnetic device disposed on an inner surface of the hub, and a second magnetic device disposed on the cover element and opposite to the first magnetic device.

18. The motor of claim 17, wherein the first magnetic device and the second magnetic device are magnets, electromagnets, or magnetic conductive devices.

19. The motor of claim 9, wherein the rotor structure further comprises a shell connected to the hub.

20. The motor of claim 9, wherein the rotor structure further comprises a plurality of blades around the rotor structure.
